(19) United States
(12) Patent Application Publication
(10) Pub. No.: US 2023/0093625 A1
(43) Pub. Date: Mar. 23, 2023

(54) INJECTION MOLDING SYSTEM WITH ACTUATOR FOR LOADING OR UNLOADING MOLDS

(71) Applicant: Canon Virginia, Inc., Newport News, VA (US)

(72) Inventors: Tomohiro Shima, Yorktown, VA (US); Tomoaki Hokyo, Foothill Ranch, CA (US)

(73) Assignee: CANON U.S.A., INC., MELVILLE, NY (US)

(21) Appl. No.: 17/482,158

(22) Filed: Sep. 22, 2021

(51) Int. Cl. B29C 45/17; B29C 45/80

(52) U.S. Cl. CPC B29C 45/1756; B29C 45/1742; B29C 45/80; B29C 2945/76013; B29C 2945/76113; B29C 2945/76321; B29C 2945/76799

(57) ABSTRACT

An injection molding system and method that injects resin into a mold and conveys at least one mold, wherein the improvement to the injection molding system and method includes driving a support member that supports the mold, wherein the mold is conveyed based on a movement of the support member between a first position where the injection nozzle injects the resin into the mold and second position different from the first position.

### FIELD

The present disclosure relates to an injection molding system for manufacturing positive chip components.

### BACKGROUND

Current manufacturing of a molded part by an injection molding system includes clamping a mold, injecting a resin into the mold, pushing the resin into the mold at high pressure to compensate for volume reduction caused by solidification of the resin, securing the molded part in the mold until the resin solidifies, and removing the molded part from the mold. Each of these injection molding steps is repeated as needed.

After performing a molding process a predetermined number of molds with a mold, the molds are unloaded from the injection molding machine. A changeover for a new mold is performed, and the new mold is inserted into the injection molding system. The new mold is then used for a predetermined number of injection molding cycles. This process can often take time and resources, and typically the injection molding system remains in a standby state during this process. This can impact overall productivity. In addition, since molds are typically heavy and heated during use, it is necessary to consider operator safety.

In order to increase productivity, a method using two molds per injection molding system has been proposed. For example, Japanese Patent Publication No. 6121601 describes a system in which two conveying devices independent of an injection molding machine are arranged on both sides of the injection molding machine. In this system, a molded part is manufactured while multiple molds are replaced by a conveying device for one injection molding machine. The conveying device used in the injection molding system of Japanese Patent Publication No. 6121601 includes independent drive sources for each mold and a controller independent from the injection molding machine, which complicates the system.

### SUMMARY

According to an aspects of the present disclosure, an injection molding system includes an injection nozzle that injects a resin into a mold and an actuator that controls conveying at least one mold, wherein an improvement of the injection molding system includes the actuator driving a support member that supports a mold, wherein the mold is conveyed, based on a movement of the support member, between a first position where the injection nozzle injects the resin and a second position that is different from the first position.

### BRIEF DESCRIPTION OF THE DRAWINGS

The accompanying drawings, which are incorporated herein and form part of the specification, illustrate various embodiments, objects, features, and advantages of the present disclosure.

FIG. 1 illustrates an injection molding system according to an exemplary embodiment.

FIG. 2 illustrates an injection molding system according another exemplary embodiment.

FIG. 3 illustrates an injection molding system according to yet another exemplary embodiment.

FIG. 4 illustrates an injection molding system according to still yet another exemplary embodiment.

FIG. 5 illustrates an injection molding system according to another exemplary embodiment.

FIG. 6 illustrates an injection molding system according to another exemplary embodiment.

FIG. 7 illustrates an injection molding system according to yet another exemplary embodiment.

FIGS. 8A and 8B illustrate an injection molding system according to an exemplary embodiment.

FIG. 9A illustrates an injection molding system according to an exemplary embodiment.

FIG. 9B is a diagram illustrating details of a mold changing table.

FIG. 10 illustrates an injection molding system according to an exemplary embodiment.

FIG. 11 is a flow chart illustrating an operation of an injection molding system according to an exemplary embodiment.

Throughout the Figures, the same reference numerals and characters, unless otherwise stated, are used to denote like features, elements, components or portions of the illustrated embodiments. While the subject disclosure is described in detail with reference to the Figures, it is done so in connection with the illustrative exemplary embodiments. It is intended that changes and modifications can be made to the described exemplary embodiments without departing from the true scope and spirit of the subject disclosure as defined by the appended claims.

### DESCRIPTION OF THE EMBODIMENTS

An injection molding system according to an exemplary embodiment will be described with reference to the drawings. In each of the drawings, arrows X and Y denote horizontal axis directions orthogonal to each other, and arrows Z denote vertical axis directions.

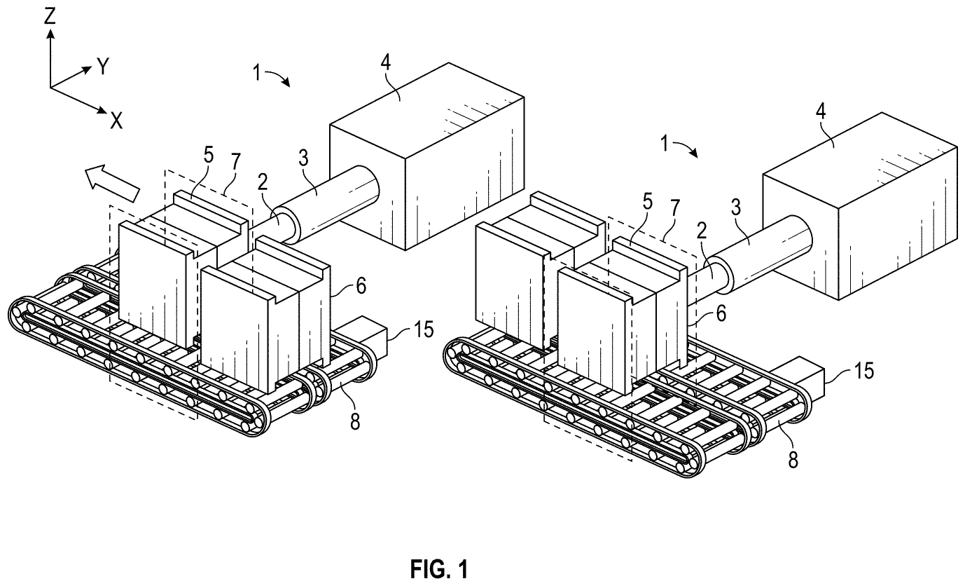

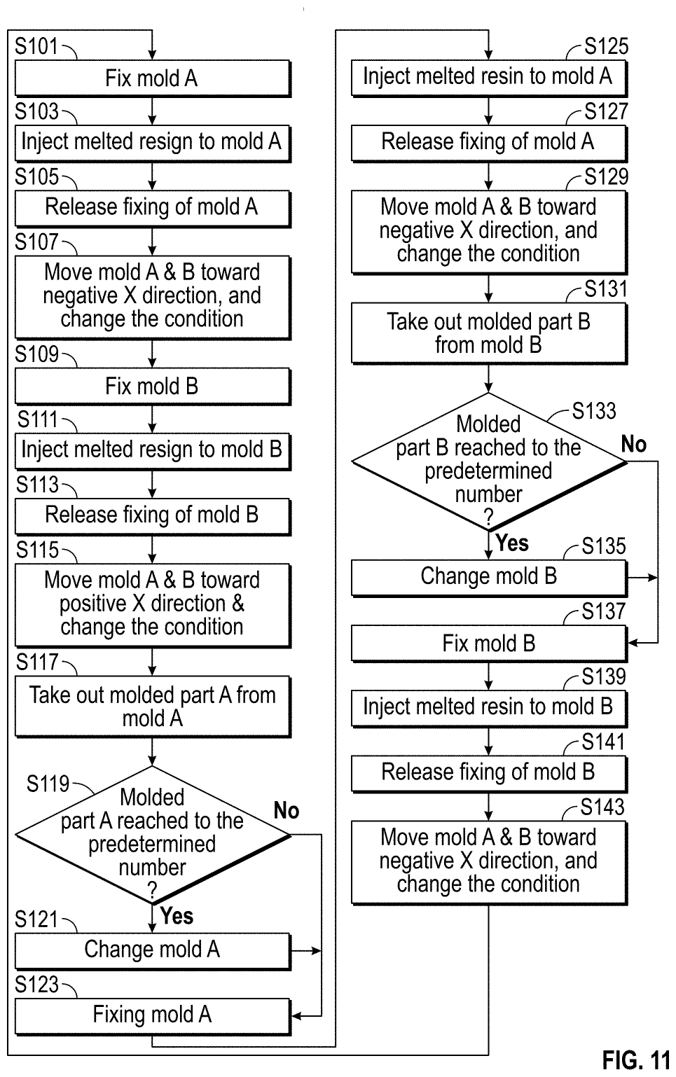

An operation of the injection molding system 1 according to an exemplary embodiment will be described in detail below with reference to FIG. 1 and FIG. 11. FIG. 1 illustrates an injection molding system 1 according to an exemplary embodiment. The left side of FIG. 1 illustrates pre-conveyance of molds while the right side illustrates post conveyance of molds. FIG. 11 is a flow chart illustrating an operation of the injection molding system 1 according to an exemplary embodiment. Each of the steps described with reference to FIG. 11 is realized by a processor (controller) (not illustrated) of the injection molding system 1 reading and executing a pre-determined program stored in a memory.

The injection molding system 1 includes an injection unit 4 including an injection nozzle 2 and an injection cylinder 3 and performs an injection process by moving the mold A 5 and the mold B 6. When the resin is injected, the mold is fixed by the platen 7. A changing/moving operation of the mold is performed via a support member (chain conveyor 8) that is moved by an actuator 15.

In the present exemplary embodiment, the support member is a member that supports a mold into which a resin is injected by an injection molding machine from below in the vertical-axis direction. In the present exemplary embodiment, a processor (not illustrated) controls operation of the injection unit 4, setting and control of a plasticizing condition and the injection condition of the resin, control of a cooling time, and movement control of the mold by the support member. This simplifies the molding system compared to implementing multiple processors. In another exemplary embodiment, some of the above-described processes can be executed by different processors.

Turning to FIG. 11, resin melted and mixed by the injection cylinder 3 is fed to the injection nozzle 2 (step not illustrated in FIG. 11),In step S101, the mold A 5 is fixed by the platen 7. Next, in step S103, resin fed to the injection nozzle 2 is injected into the mold A 5, and a cooling time counting for the mold A 5 begins.

Plasticization conditions and injection conditions of the resin to the mold A 5 are executed under a preset condition A. For example, preset condition A can include setting a resin temperature, an injection filling speed, and a packing pressure so that a flowability of resin can be secured in a mold.

After the cooling time counting begins, in step S105, clamping of the mold A 5 by the platen 7 is released at a predetermined time after the cooling time counting starts and the chain conveyor 8 is operated. In step S107, the mold A 5 and the mold B 6 are conveyed in a negative X-axis direction (FIG. 1), and the mold B 6 is fixed by the platen 7 in step S109.

During the above-described process, the plasticizing condition and the injection condition of the resin set in the injection unit 4 are changed from the preset condition A to a preset condition B. Preset conditions A and B can either be the same condition or different conditions. In step S111, resin melted and mixed under preset condition B is injected into the mold B 6 fixed to the platen 7. A cooling time counting for the mod B 6 is then started.

In step S113, after the cooling time counting is started, clamping of the mold B 6 by the platen 7 is released at a predetermined time after the cooling time counting starts. In step S115, the mold A 5 and the mold B 6 are conveyed in a positive X-axis direction (FIG. 1) as the chain conveyor 8 is operated, and the mold A 5 is re-fixed by the platen 7.

In step S117, when the cooling time for the mold A 5 elapses, the mold A 5 is opened by a mold opening operation of the platen 7, and a resin molded part A (not illustrated) in the mold A 5 is removed. Next, in step S119, a determination is made whether the number of resin molded parts produced by the mold A 5 has reached a predetermined number. If the predetermined number is reached, flow proceeds to step S121. In step S121, the mold A 5 is replaced with another mold. If the predetermined number has not been reached, flow proceeds to step S123.

In step S123, the mold A 5 is closed by the mold clamping operation of the platen 7 after the resin molded parts (not illustrated) are removed. Then, in step S125, resin melted under the pre-set condition A is injected.

Next, in step S127, after the cooling time counting begins, clamping of the mold A 5 by the platen 7 is released at a predetermined time after the cooling time counting started. In step S129, the chain conveyor 8 is operated to move the mold A 5 and the mold B 6 in a negative X-axis direction (FIG. 1), and the mold B 6 is fixed by the platen 7. In step S131, when the cooling time elapses for the mold B 6, the mold B 6 is opened by a mold operation of the platen 7, and a resin molded part B (not illustrated) in the mold B 6 is removed.

In step S133, it is determined whether the number of the resin molded parts B produced by the mold B6 has reached a predetermined number. If it is determined that the predetermined number has been reached, the flow proceeds to step S135. In step S135, the mold B 6 is replaced with another mold. If it is determined that the predetermined number has not been reached, the flow proceeds to step S137.

In step S137, the mold B 6 is closed by the mold clamping operation of the platen 7 after the resin molded parts B are removed. Then, in step S139, melted resin is injected based on the preset condition B.

In step S141, after the cooling time counting begins, clamping of the mold B 6 by the platen 7 is released at a predetermined time after the cooling time counting started., In step S143, the chain conveyor 8 is operated to move the mold A 5 and the mold B 6 in a negative X-axis direction (FIG. 1), and process returns to step S101, were the mold A 5 is re-fixed by the platen 7.

In the above-described process, when the support member repeatedly conveys a mold in the X-axis direction, injection and cooling of the mold A 5 and the mold B 6 and removal of the molded parts are repeated. In the present exemplary embodiment, operation of the support member is accomplished via an operation panel (not illustrated) for setting a resin plasticizing condition or an injection molding condition of the injection molding system 1. However, this is not seen to be a limiting implementation, and any method that would enable operation of the support member is applicable.

Returning to FIG. 1, as described above, in the present exemplary embodiment, the support member is a chain conveyor 8. A chain supporting a bottom surface of a mold is rotated by the actuator 15 to carry in and out the mold A 5 and the mold B 6. In one exemplary embodiment, the chain conveyor 8 can be installed on the platen 7 of the injection molding system 1 and can be installed at a lower clamp position of a mold in the vertical-axis direction.

In the present exemplary embodiment, the injection molding system 1 of FIG. 1 includes a support member in the form of a chain conveyor 8 for carrying in and out a mold. Thus, an additional conveying device external to the injection molding system 1 is not required. This enables simplifying the structure of an injection molding system, which can result in operational improvements as well as cost reduction.

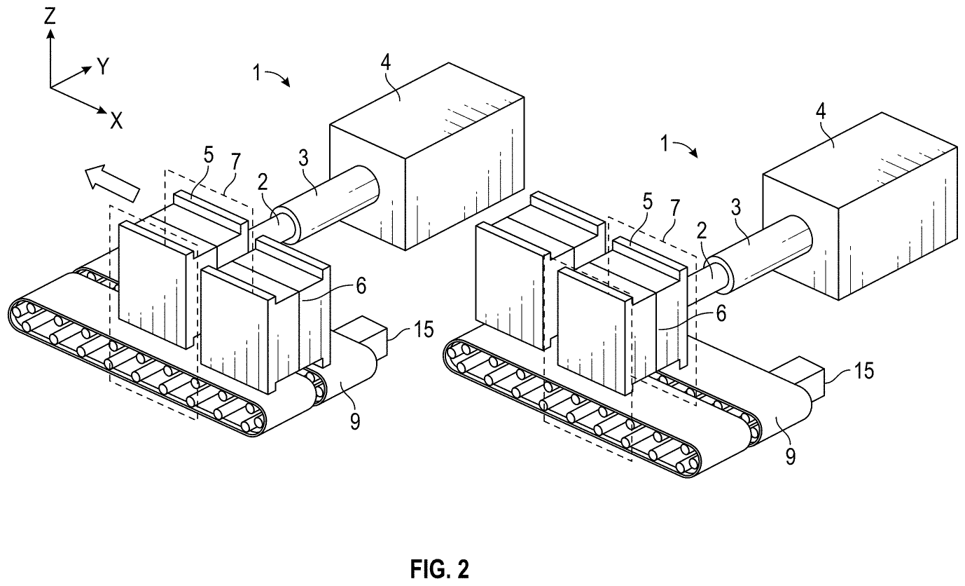

The support member is not limited to the chain conveyor 8. FIG. 2 illustrates an example in which the support member is a belt conveyor 9. The left side of FIG. 2 illustrates pre-conveyance of molds while the right side illustrates post conveyance of molds. A belt supporting a bottom surface of a mold is rotated by the actuator 15 to carry in and out the mold A 5 and the mold B 6. As with the support member 8, the belt conveyor 9 can be installed on the platen 7 of the injection molding system 1 or can be installed at the clamp position of a mold in the lower vertical-axis direction.

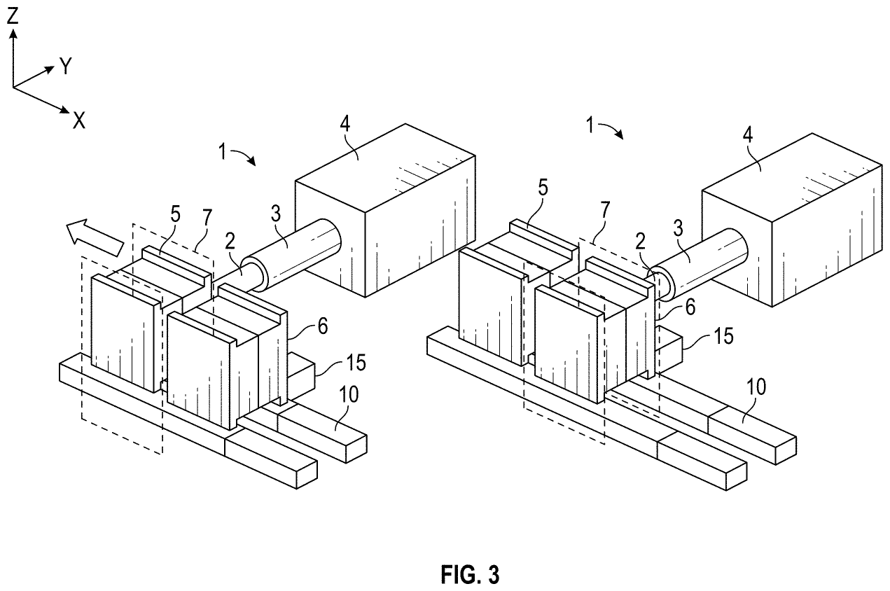

FIG. 3 illustrates an example in which the support member is an expansion conveyor 10. The left side of FIG. 3 illustrates pre-conveyance of molds while the right side illustrates post conveyance of molds. An expanding unit supporting a bottom surface of a mold is extended and contracted by the actuator 15 to carry in and out the mold A 5 and the mold B 6. As with support member 8, the expansion conveyor 10 can be provided on the platen 7 of the injection molding system 1 or can be installed at a clamp position of a mold in the lower vertical-axis direction.

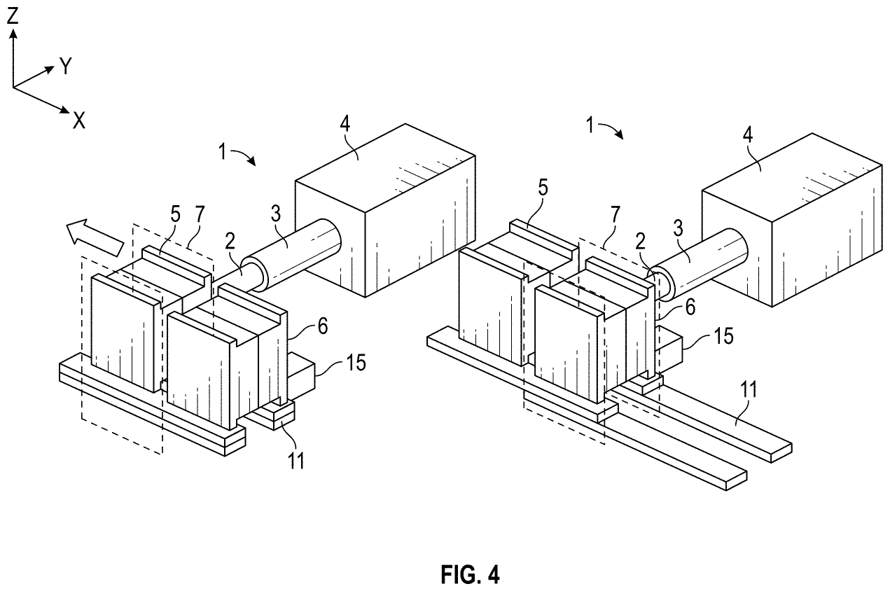

FIG. 4 illustrates an example where the support member is a slide conveyor 11. The left side of FIG. 4 illustrates pre-conveyance of molds while the right side illustrates post conveyance of molds. An expanding unit supporting a bottom surface of a mold is slid by the actuator 15 to carry in and out the mold A 5 and the mold B 6. As with the support member 8, the slide conveyor 11 can be provided on the platen 7 of the injection molding system 1 or can be provided below a clamp position of a mold in the vertical-axis direction.

FIGS. 1-4 illustrate a configuration with no connecting area between a first position for the injection process by the injection nozzle 2 and a second position different from the first position. The second position, which is generally external to the platen 7 or a tie bar (not illustrated) of the injection molding system 1, is a position for cooling a mold after the injection process is completed. Providing the second position external to the platen 7 or the tie bar, the resin can be filled into another mold.

Providing the injection molding system 1 with a mold carrying in/out function, such as a chain conveyor 8, a belt conveyor 9, an expansion conveyor 10, or a slide conveyor 11, a seamless state is formed between the first position and the second position, and a mold can be smoothly carried in/out. The above-described conveyors are all motorized. However, these are not seen to be limiting, and any conveying mechanism that would enable practice of the present disclosure is applicable.

The support member (chain conveyor 8, belt conveyor 9, expansion conveyor 10, or slide conveyor 11) in FIGS. 1-4 includes a first member that contacts a fixed side mounting plate (not illustrated) of a mold and a second member that contacts a movable side mounting plate (not illustrated) of a mold. The support member includes a slide mechanism for adjusting a distance between the first member and the second member based on a thickness of a mold. Since the distance between the first member and the second member is adjustable in the Y-axis direction, the present embodiment enables easier handling of molds with various thicknesses.

The movement amount of the support member (chain conveyor 8, belt conveyor 9, expansion conveyor 10, or slide conveyor 11) is detected by a movement sensor (not illustrated). The actuator 15 stops moving the support member based on a detection result of the moving amount detected by the moving sensor. Thus, conveyance of a mold can be based on a predetermined conveying amount. The movement sensor can also detect an amount of mold conveyance instead of the amount of support member conveyance, which can be used to control operation of the actuator 15.

The injection molding system 1 also includes a position sensor (not illustrated) that detects the position of a mold. The actuator 15 stops moving the support member based on a detection result of the position of a mold by the position sensor. Using the position sensor to control the actuator 15 enables preventing damage, for example, due to a mold colliding with a support member even if there is an erroneous input of the moving amount of the support member or an erroneous detection of the moving amount by the moving sensor.

The actuator 15 includes a force sensor (not illustrated) that detects a magnitude of force provided to the support member (chain conveyor 8, belt conveyor 9, expansion conveyor 10, or slide conveyor 11). Operation of the actuator 15 can be controlled based on a detection result by the force sensor. This enables preventing the support member from stopping and avoiding any damage in the event that a foreign matter interferes with the normal operation of the support member.

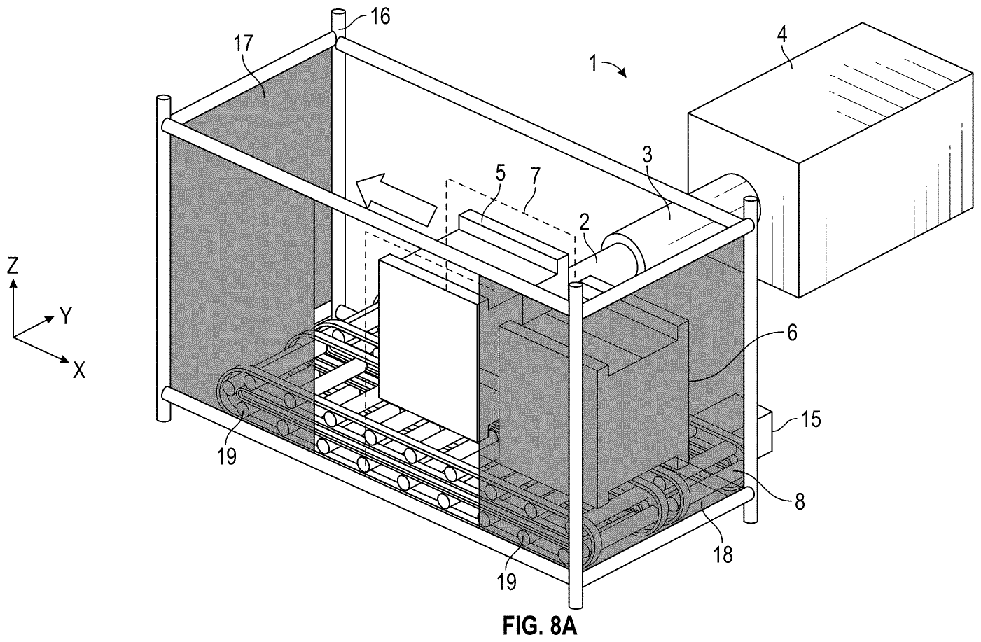

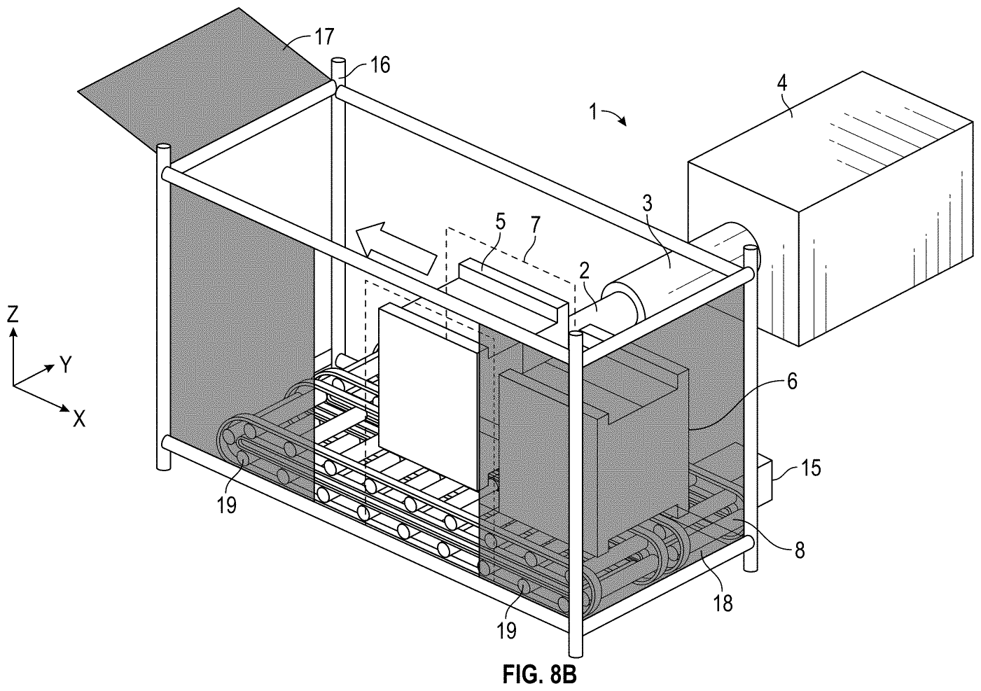

FIG. 8A illustrates a cover member that covers at least a part of the injection molding system 1. More specifically, in FIG. 8A illustrates a frame 16, an end wall 17 on a side of the mold A 5, an end wall 18 on a side of the mold B 6; and a side wall 19 that make up the cover member. The cover member as illustrated in FIG. 8A, it is possible to reduce the risk that an operator may contact a mold being conveyed or the support member, e.g., the chain conveyor 8 or the risk that a foreign matter contacts the support member.

As illustrated in FIG. 8A, the side wall 19 of the present embodiment is divided into two portions, a side of the mold A 5 and a side of the mold B 6. A clamping force generating device (platen and toggle mechanism on movable side) (not illustrated) is located in a section where the side wall 19 is divided, i.e., the section that is an opposite side of a mold viewed from the injection unit 4. A mold clamping force generating device is a device for executing a process of closing a mold by pressing a movable side mounting plate of the mold towards a fixed side mounting plate and a process of opening the mold by pulling the movable mold mounting plate of the mold in a direction opposite to the fixed side mounting plate.

The end wall 17 and the end wall 18 are doors that can be opened and closed, and can be locked to prevent them from opening during an injection molding process. When the mold A5 is replaced in step S121 of FIG. 11, the end wall 17 is unlocked. When the mold B6 is replaced in step S135 of FIG. 11, the end wall 18 is unlocked.

In the present embodiment, both end wall 17 and end wall 18 are automatically locked and unlocked. More specifically, when it is determined in step S119 of FIG. 11 that a predetermined number has been reached, the support member conveys the mold A 5 and the mold B 6 in the negative X-axis direction and end wall 17 is unlocked. Thus, an operator can manually open the end wall 17 and replace the mold A 5 with another mold.

FIG. 8B illustrates a state where the end wall 17 is opened. When the mold A 5 is replaced in step S121 of FIG. 11, the end wall 18 remains locked. When the end wall 17 is determined to be closed after replacing the mold A 5 with another mold, the end wall 17 is automatically locked. This reduces the risk of unintentionally opening the end wall 17.

If it is determined in step S133 of FIG. 11 that the predetermined number has been reached, the support member conveys the mold A 5 and the mold B 6 in the positive X-axis direction and the end wall 17 is unlocked. Thus, an operator can manually open the end wall 17 and replace the mold B 6 with another mold. When the mold B 6 is replaced in step 135 of FIG. 11, the end wall 16 remains locked. When it is determined that the end wall 17 is closed after replacing the mold B 6 with another mold, the end wall 17 is automatically locked.

In the present embodiment, the end wall 17 and end wall 18 are locked and unlocked by the injection molding systems 1 processor (not illustrated).. In another exemplary embodiment, the end wall 17 and the end wall 18 can, for example, be locked by a magnet. Any method of locking and unlocking the end wall 17 and the end wall 18 that would enable practice of the present disclosure is applicable.

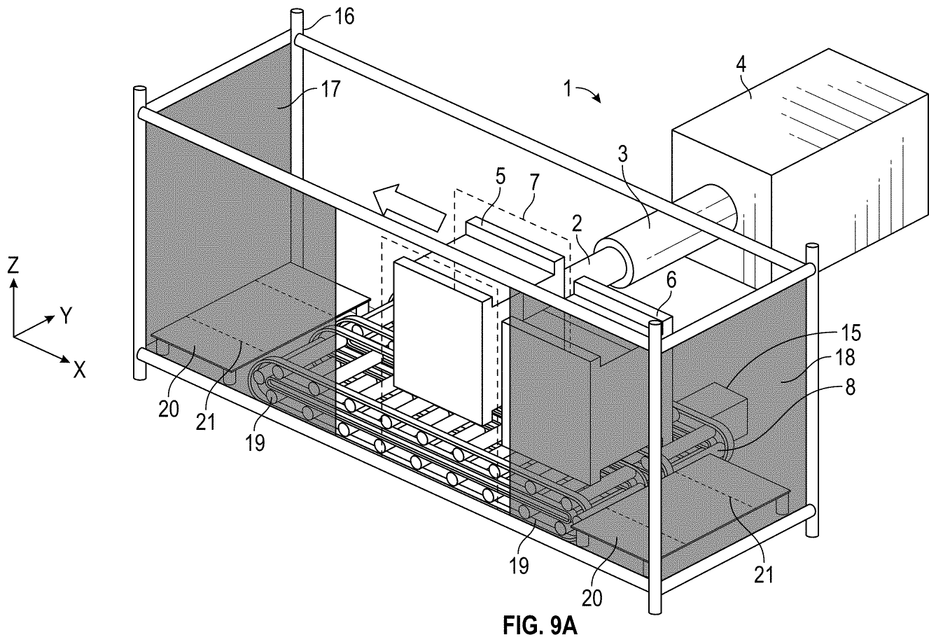

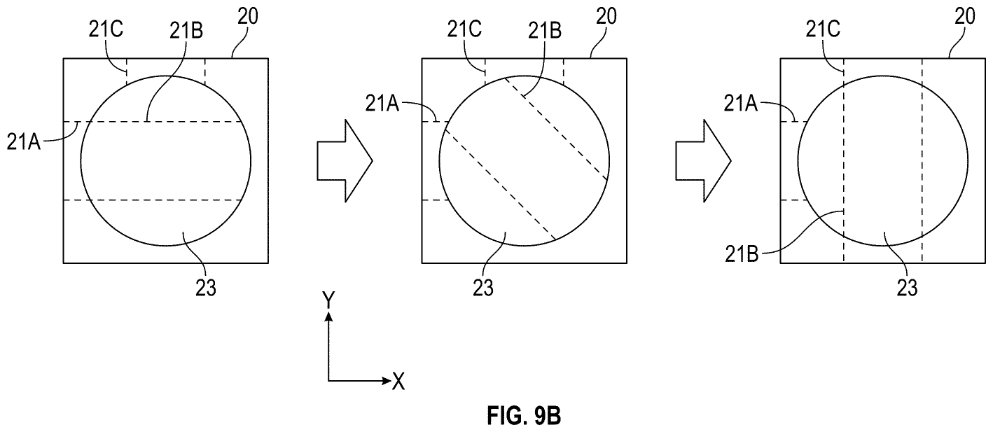

FIG. 9A illustrates another exemplary embodiment of a cover member. In addition to the elements described in FIGS. 8A and 8B, FIG. 9A includes a mold change table 20 and a guide roller 21. When it is determined in step S119 of FIG. 11 the support member, e.g., the chain conveyor 8 moves the mold A 5 and the mold B 6 in a negative X-axis direction until the mold A 5 is placed on the mold change table 20. In the present exemplary embodiment, the guide roller 21 is a roller member that supports the movement of the mold A 5 onto the mold change table 20. The mold A 5 moves onto the mold change table 20 via rotation of the guide roller 21. The mold change table 20 includes a rotation function around the Z-axis direction, where it rotates 90 degrees around the Z-axis direction with a mold mounted thereon.

FIG. 9B illustrates a configuration of the mold change table 20. The mold change table 20 includes a disk 23. The guide roller 21 is includes a guide roller 21A connected to the support member, a guide roller 21B located on the disk 23, and a guide roller 21C located in a removal direction of a mold. When it is determined in step S121 of FIG. 11 that the mold A 5 is placed on the disk 23, the disk 23 rotates 90 degrees around the Z-axis direction, and the mold A 5 is moved in the Y-axis direction.

The configuration of FIG. 9B enables a mold to be replaced from an opposite side of the side wall 19 (i.e., a side of the injection molding system 1). The side wall 19 can be opened and closed and the mold A5 can be removed via the side wall 19. In this case, the disk 23 rotates 90 degrees in an opposite direction to the above description.

The end wall 18 and the side wall 19 can open and close as in FIGS. 8A and 8B, and the mold A 5 on the mold change table 20 can be removed from the end wall 17 side. In this case, the mold change table 20 does not require a rotating function.

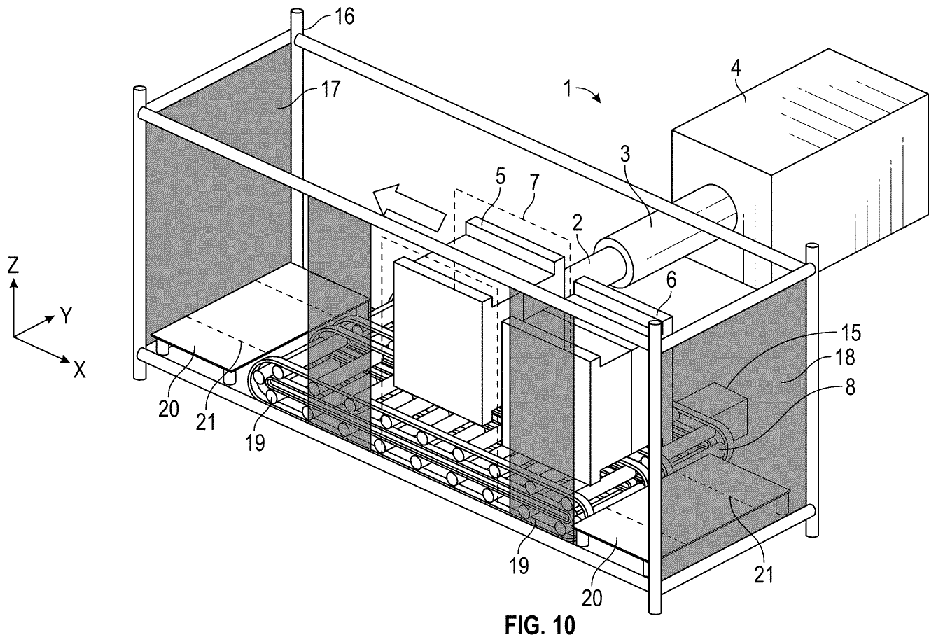

FIG. 10 illustrates another exemplary embodiment of a cover member. The cover member in FIG. 10 differs in the size of the side wall 19 from the size of the side wall 19 illustrated in FIG. 9A. When it is determined in step S119 of FIG. 11 that a predetermined number has been reached, the support member, e.g., the chain conveyor 8 moves the mold A 5 and the mold B 6 in a negative X-axis direction until the mold A 5 is placed on the mold change table 20. The mold A 5 is conveyed to the mold change table 20 via rotation of the guide roller 21. The mold change table 20 includes a rotation function around the Z-axis direction, where it rotates 90 degrees around the Z-axis direction with the mold mounted thereon. Thus, a mold can be changed from the side wall 19 side.

FIGS. 8A-10 illustrate exemplary embodiments where a cover member is applied to the injection molding system 1 of FIG. 1, which includes the chain conveyor 8 as the support member. Each of the cover member exemplary embodiments can be applied to the injection molding system 1 of FIGS. 2-4.

The above-described exemplary embodiments have described the carrying in/out directions of the mold A 5 and the mold B 6 as being in the X-axis direction. They carrying in/out direction is not limited to the X-axis direction. In another exemplary embodiment, the direction can be in the Z-axis direction.

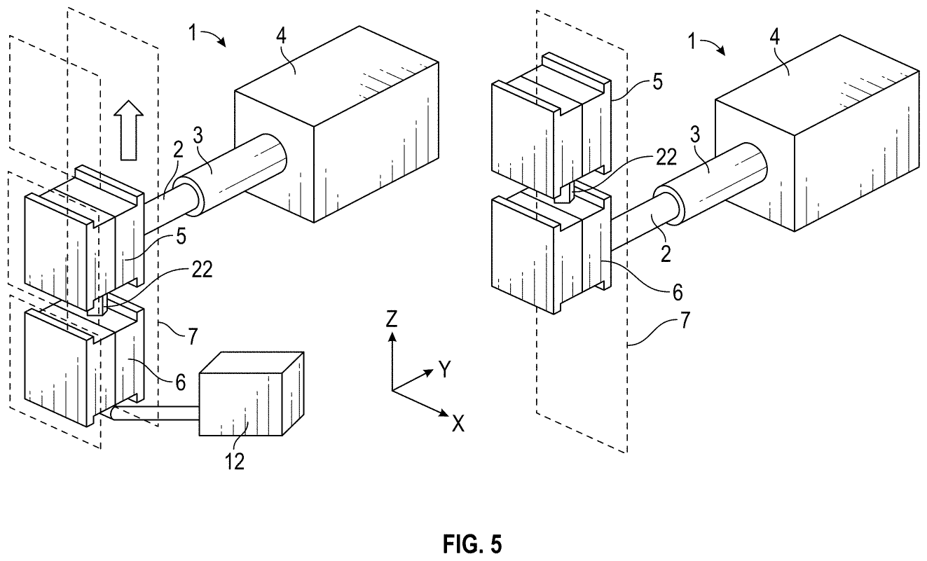

FIG. 5 illustrates an exemplary embodiment where an electric lifter 12 is used to move a mold in a Z-axis direction.

In FIG. 5, the electric lifter 12 is connected to the mold B 6, and the mold A 5 and the mold B 6 are connected to each other by a connection part 22. In another exemplary embodiment, the electric lifter 12 can also be connected to the mold A 5. An operation of the injection molding system 1 of the present embodiment will be described in detail below with reference to FIG. 5 and FIG. 11.

In general, the steps of FIG. 11 are applicable to the operation of the injection molding system 1 of FIG. 5. As such, only the differences in the operation that are specifically associated with FIG. 5 will be described in detail below.

In the present embodiment, the configuration of the electric lifter 12 results in conveyance of the mold A 5 and the mold B 6 in a positive Z-axis direction in step S107 of FIG. 1,

In the present embodiment, the configuration of the electric lifter 12 results in conveyance of the mold B6 in a negative Z-axis direction in step S115 of FIG. 11.

In the present embodiment, the configuration of the electric lifter 12 results in conveyance of the mold A 5 in a positive Z-axis direction in step S129 of FIG. 11.

In the present embodiment, the configuration of the electric lifter 12 results in conveyance of the mold B 6 in a negative Z-axis direction in step S143 of FIG. 11.

In the present embodiment, when the electric lifter 12 repeatedly conveys a mold in a Z-axis direction, injection and cooling of the mold A 5 and the mold B 6 and removal of a resin molded part is repeated.

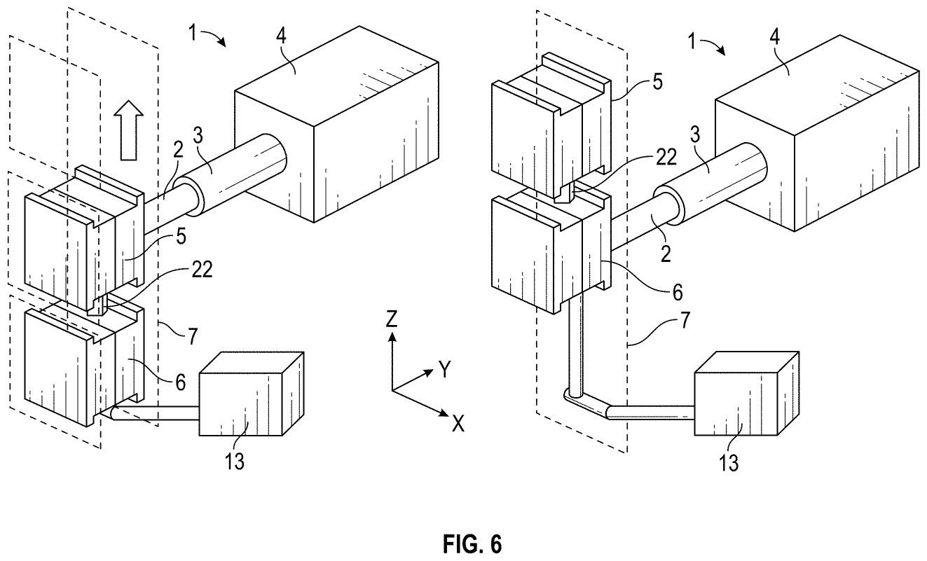

As illustrated in FIG. 5, the electric lift 12 acts as the actuator 15 from FIG. 1. When the electric lift 12 connected to a mold moves up and down and is carried in and out. The electric lifter 12 can be installed on the platen 7 of the injection molding system 1 or can be installed below a clamp position of a mold in vertical-axis direction. In the present embodiment of FIG. 5, an actuator (not illustrated) for conveying a mold i a Z-axis direction is also provided, which removes the need to attach a transport device external to the injection molding system 1. This enables simplifying the structure of an injection molding system, which can result in operational improvements as well as cost reduction. FIG. 6 illustrates an exemplary embodiment where a hydraulic lifter 13 is used to move a mold in a Z-axis direction. The left side of FIG. 6 illustrates pre-conveyance of molds while the right side illustrates post conveyance of molds. When the hydraulic lifter 13 is connected to a mold and moves up and down, the mold A 5 and the mold B 6 are carried in and out. The hydraulic lifter 13 can be installed on the platen 7 of the injection molding system 1 or can be installed below a clamp position of a mold in a vertical-axis direction.

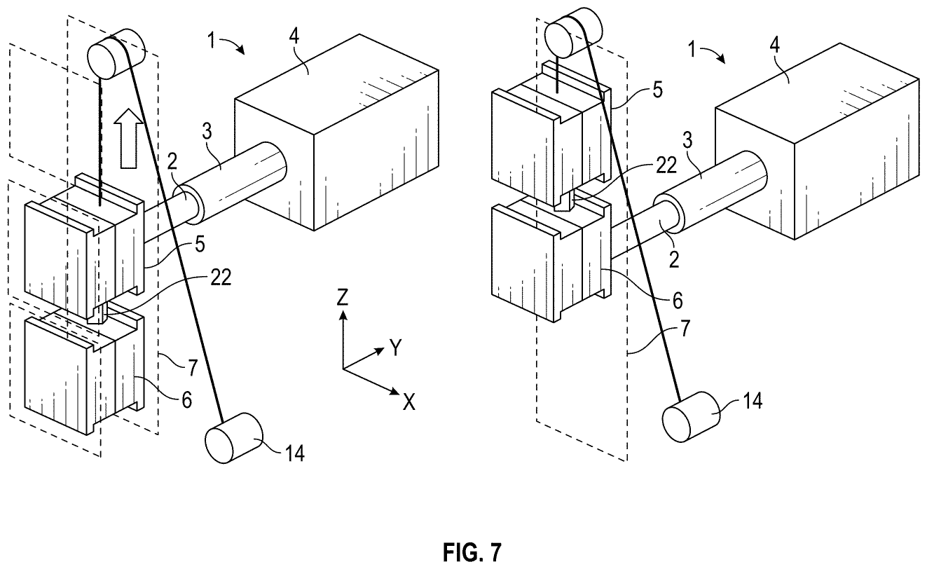

FIG. 7 illustrates an exemplary embodiment where a hoister 14 using a pulley is used to move a mold in the Z-axis direction. The left side of FIG. 7 illustrates pre-conveyance of molds while the right side illustrates post conveyance of molds. A top surface of an upper mold and the hoister 14 are connected by a wire, and the mold A 5 and the mold B 6 are carried in and out by performing a lifting operation. The hoister 14 can be mounted on the platen 7 of the injection molding system 1 or can be mounted in a vertical-axis direction at a clamp position of a mold.

### DEFINITIONS

In referring to the description, specific details are set forth in order to provide a thorough understanding of the examples disclosed. In other instances, well-known methods, procedures, components and circuits have not been described in detail as not to unnecessarily lengthen the present disclosure.

It should be understood that if an element or part is referred herein as being “on”, “against”, “connected to”, or “coupled to” another element or part, then it can be directly on, against, connected or coupled to the other element or part, or intervening elements or parts may be present. In contrast, if an element is referred to as being “directly on”, “directly connected to”, or “directly coupled to” another element or part, then there are no intervening elements or parts present. When used, term “and/or”, includes any and all combinations of one or more of the associated listed items, if so provided.

Spatially relative terms, such as “under” “beneath”, “below”, “lower”, “above”, “upper”, “proximal”, “distal”, and the like, may be used herein for ease of description to describe one element or feature's relationship to another element(s) or feature(s) as illustrated in the various figures. It should be understood, however, that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, a relative spatial term such as “below” can encompass both an orientation of above and below. The device may be otherwise oriented (rotated 90 degrees or at other orientations) and the spatially relative descriptors used herein are to be interpreted accordingly. Similarly, the relative spatial terms “proximal” and “distal” may also be interchangeable, where applicable.

The term “about,” as used herein means, for example, within 10%, within 5%, or less. In some embodiments, the term “about” may mean within measurement error.

The terms first, second, third, etc. may be used herein to describe various elements, components, regions, parts and/or sections. It should be understood that these elements, components, regions, parts and/or sections should not be limited by these terms. These terms have been used only to distinguish one element, component, region, part, or section from another region, part, or section. Thus, a first element, component, region, part, or section discussed below could be termed a second element, component, region, part, or section without departing from the teachings herein.

The terminology used herein is for the purpose of describing particular embodiments only and is not intended to be limiting. The use of the terms “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “includes”, “including,” and “containing” are to be construed as open-ended terms (i.e., meaning “including, but not limited to,”) unless otherwise noted. Specifically, these terms, when used in the present specification, specify the presence of stated features, integers, steps, operations, elements, and/or components, but do not preclude the presence or addition of one or more other features, integers, steps, operations, elements, components, and/or groups thereof not explicitly stated. Recitation of ranges of values herein are merely intended to serve as a shorthand method of referring individually to each separate value falling within the range, unless otherwise indicated herein, and each separate value is incorporated into the specification as if it were individually recited herein. For example, if the range 10-15 is disclosed, then 11, 12, 13, and 14 are also disclosed. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

It will be appreciated that the methods and compositions of the instant disclosure can be incorporated in the form of a variety of embodiments, only a few of which are disclosed herein. Variations of those embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. An injection molding system comprising:
an injection nozzle that injects a resin into a mold; and
an actuator that controls conveying at least one mold,
wherein an improvement of the injection molding system includes:
the actuator driving a support member that supports a mold, and
wherein the mold is conveyed, based on a movement of the support member, between a first position where the injection nozzle injects the resin into the mold and a second position different from the first position.

2. The injection molding system according to claim 1, wherein the support member is a chain conveyor.

3. The injection molding system according to claim 1, wherein the support member is a belt conveyor.

4. The injection molding system according to claim 1, wherein the support member is an expansion conveyor.

5. The injection molding system according to claim 1, wherein the support member is a slide conveyor.

6. The injection molding system according to claim 1, wherein the support member connects the first position and the second position.

7. The injection molding system according to claim 1, wherein the second position is a position for cooling the mold after the resin has been injected into the mold.

8. The injection molding system according to claim 1, wherein the support member includes:
a first member that contacts a fixed portion of the mold,
a second member that contacts a movable portion of the mold, and
an adjustment mechanism that adjusts a distance between the first member and the second member.

9. The injection molding system according to claim 1, further comprising:
a motion sensor that detects the moving amount of the support member, and
a controller that controls stopping the actuator from driving the support member based on a detection result of the motion sensor.

10. The injection molding system according to claim 1, further comprising:
a position sensor that detects a position of the mold, and
a controller that controls stopping the actuator from driving the support member based on a detection result of the position sensor.

11. The injection molding system according to claim 1, further comprising:
a force sensor that detects a force supplied by the actuator to the support member, and
a controller for stopping the actuator from driving the support member based on a detection result of the force sensor.

12. The injection molding system according to claim 1, further comprising a cover member that covers at least a portion of the support member,
wherein the cover member includes a door that opens and closes, wherein opening the door enables replacing the mold.

13. The injection molding system according to claim 1, further comprising a mold change table, wherein and the mold is conveyed into the mold change table to facilitate changing the mold with a different mold.

14. The injection molding system according to claim 13, wherein the mold change table includes a rotating mechanism that rotates around a vertical-axis, wherein the rotation mechanism executes rotation around the vertical-axis when the mold is positioned on the mold change table.

15. An injection molding system, comprising
an injection nozzle that injects resin into a mold; and
an actuator that conveys at least one mold,
wherein an improvement of the injection molding system includes:
the actuator conveys the mold in a vertical-axis direction between a first position where the injection nozzle injects the resin into the mold and a second position different from the first position.

16. The injection molding system according to claim 15, wherein the actuator is an electric lifter.

17. The injection molding system according to claim 15, wherein the actuator is a hydraulic lifter.

18. The injection molding system according to claim 15, wherein the actuator is a hoisting device.

19. A method for manufacturing molded products, the method comprising:
injecting resin into a mold; and
conveying at least one mold,
wherein an improvement of the method includes:
driving a support member that supports a mold, and
conveying the mold, based on a movement of the support member, between a first position where the injection nozzle injects the resin into the mold and a second position different from the first position.

20. A method for manufacturing molded products, the method comprising:
injecting resin into a mold; and
conveying at least one mold,
wherein an improvement of the method includes:
conveying the mold in a vertical-axis direction between a first position where the injection nozzle injects the resin into the mold and a second position different from the first position.
